(19) United States
(12) Patent Application Publication
(10) Pub. No.: US 2019/0071043 A1
(43) Pub. Date: Mar. 7, 2019

(54) ADVANCED COLLISION DETECTION AND ENHANCED AUTOMOTIVE CRASH NOTIFICATION

(71) Applicant: Panasonic Automotive Systems Company of America, Division of Panasonic Corporation of North America, PEACHTREE CITY, GA (US)

(72) Inventor: SATPREET SINGH, FAYETTEVILLE, GA (US)

(73) Assignee: Panasonic Automotive Systems Company of Americ Division of Panasonic Corporation of North America

(21) Appl. No.: 16/121,890

(22) Filed: Sep. 5, 2018

Related U.S. Application Data
(60) Provisional application No. 62/554,736, filed on Sep. 6, 2017.

(51) Int. Cl. B60R 21/01; B60W 30/095; G07C 5/00

(52) U.S. Cl. CPC B60R 21/01; B60W 30/0953; B60R 2021/0027; G07C 5/008; B60R 2021/01013; B60W 30/0956

(57) ABSTRACT

A crash notification arrangement for a motor vehicle includes a plurality of sensors detecting a plurality of conditions associated with operation of the motor vehicle. The sensors produce sensor signals indicative of the detected conditions. An electronic processor is communicatively coupled to the sensors and receives the sensor signals. The electronic processor determines, based upon the sensor signals, that the motor vehicle will be involved in a collision in the near future. In response to the determining of the near future collision, sensor data based on the sensor signals is stored in memory. The electronic processor ascertains, based upon the sensor signals, that the motor vehicle has been involved in a collision. In response to the ascertaining that a collision has occurred, the stored sensor data is transmitted to an entity that is disposed at a location that is remote from the motor vehicle.

### CROSS-REFERENCE TO RELATED APPLICATION

This application claims benefit of U.S. Provisional Application No. 62/554,736 filed on Sep. 6, 2017, which the disclosure of which is hereby incorporated by reference in its entirety for all purposes.

### FIELD OF THE INVENTION

The disclosure relates to a collision detection and notification system in a motor vehicle.

### BACKGROUND OF THE INVENTION

Current automotive crash notification programs provide information on the location of the vehicle and provide internal information on the number of passengers, seat belt status and some other information about vehicle internals. This information is not sufficient for root causing a crash, especially in the case of hit and run, insurance frauds, and the case where the occupant of the vehicle dies in the crash.

### SUMMARY

The present invention may improve crash detection as well as automotive crash notification data by providing additional information that has not conventionally been provided. The information may be about video images of a scene surrounding the vehicle, and vehicle to vehicle (V2V) and vehicle to everything (V2X) communication data.

Accident prevention algorithms taking into account the velocity and acceleration of surrounding objects can easily determine if an accident is imminent. In response to this situation, the available cameras around the vehicles may begin recording video information that may help authorities to determine the cause of the crash. Also, if supported by the vehicle, vehicle to vehicle communication and vehicle to everything communication may also begin to record information. When the automotive crash notification is received, the videos and V2V and V2X information may also be sent to the authorities along with the current GPS coordinates, vehicle internal data, and a recorded audio emergency call from the vehicle, if such is supported by the vehicle.

In one embodiment, the invention comprises a crash notification arrangement for a motor vehicle, including a plurality of sensors detecting a plurality of conditions associated with operation of the motor vehicle. The sensors produce sensor signals indicative of the detected conditions. An electronic processor is communicatively coupled to the sensors and receives the sensor signals. The electronic processor determines, based upon the sensor signals, that the motor vehicle will be involved in a collision in the near future. In response to the determining of the near future collision, sensor data based on the sensor signals is stored in memory. The electronic processor ascertains, based upon the sensor signals, that the motor vehicle has been involved in a collision. In response to the ascertaining that a collision has occurred, the stored sensor data is transmitted to an entity that is disposed at a location that is remote from the motor vehicle.

In another embodiment, the invention comprises a method for reporting a collision of a motor vehicle, including detecting a plurality of conditions associated with operation of the motor vehicle. Sensor signals indicative of the detected conditions are produced. It is determined, based upon the sensor signals, that the motor vehicle will be involved in a collision in the near future. In response to the determining of the near future collision, sensor data is stored in a memory device. The sensor data is based on the sensor signals. It is ascertained, based upon the sensor signals, that the motor vehicle has been involved in a collision. In response to the ascertaining that a collision has occurred, the stored sensor data is transmitted to an entity that is disposed at a location that is remote from the motor vehicle.

In yet another embodiment, the invention comprises a motor vehicle including a plurality of sensors detecting a plurality of conditions associated with operation of the motor vehicle, and producing sensor signals indicative of the detected conditions. An electronic processor is communicatively coupled to the sensors and to a memory device that is disposed within the motor vehicle. The electronic processor receives the sensor signals, and stores sensor data in the memory device. The sensor data is based on the sensor signals. The electronic processor ascertains, based upon the sensor signals, that the motor vehicle has been involved in a collision, and, in response, transmits the stored sensor data to an entity that is disposed at a location that is remote from the motor vehicle.

An advantage of the present invention is that, if a vehicle is in a collision or accident, evidence regarding the root cause for the accident is available. The invention may also help determine the root cause in hit and run cases, insurance fraud cases, and in cases where the occupant of the vehicle dies in the crash.

### BRIEF DESCRIPTION OF THE DRAWINGS

A better understanding of the present invention will be had upon reference to the following description in conjunction with the accompanying drawings.

FIG. 1 is a block diagram of one example embodiment of a crash notification arrangement of the present invention for a motor vehicle.

FIG. 2 is a diagram of a first step of one example use case of the arrangement of FIG. 1.

FIG. 3 is a diagram of a second step of the example use case of FIG. 2.

FIG. 4 is a flow chart of one example embodiment of a method of the present invention for reporting a collision of a motor vehicle.

### DETAILED DESCRIPTION OF THE PREFERRED EMBODIMENTS

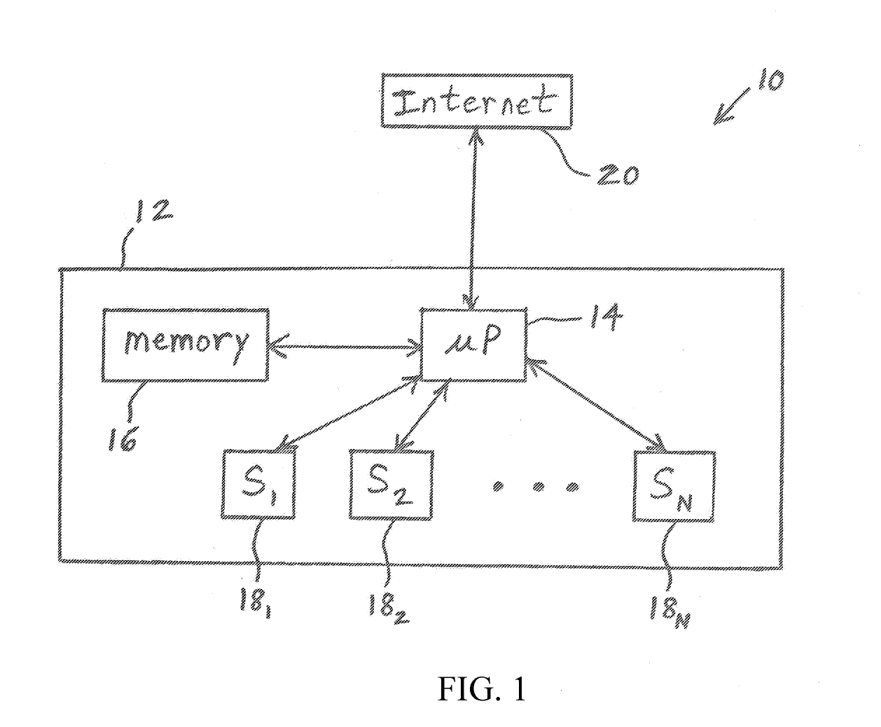

FIG. 1 illustrates one example embodiment of a crash notification arrangement 10 of the present invention for a motor vehicle 12. Arrangement 10 includes an electronic processor 14 in bi-directional communication with a memory device 16, with sensors 18_{1-N}, and wirelessly with Internet 20. Sensors 18 may include a GPS module, cameras, a speedometer, accelerometers, radar detection sensors, microphones, collision sensors, V2V data collectors, and V2X data collectors, for example. Information and data collected from sensors 18 may be recorded in memory device 16. In the event of a crash, data collected from sensors 18 may be retrieved from memory 16 and wirelessly transmitted to authorities (e.g., police) via Internet 20.

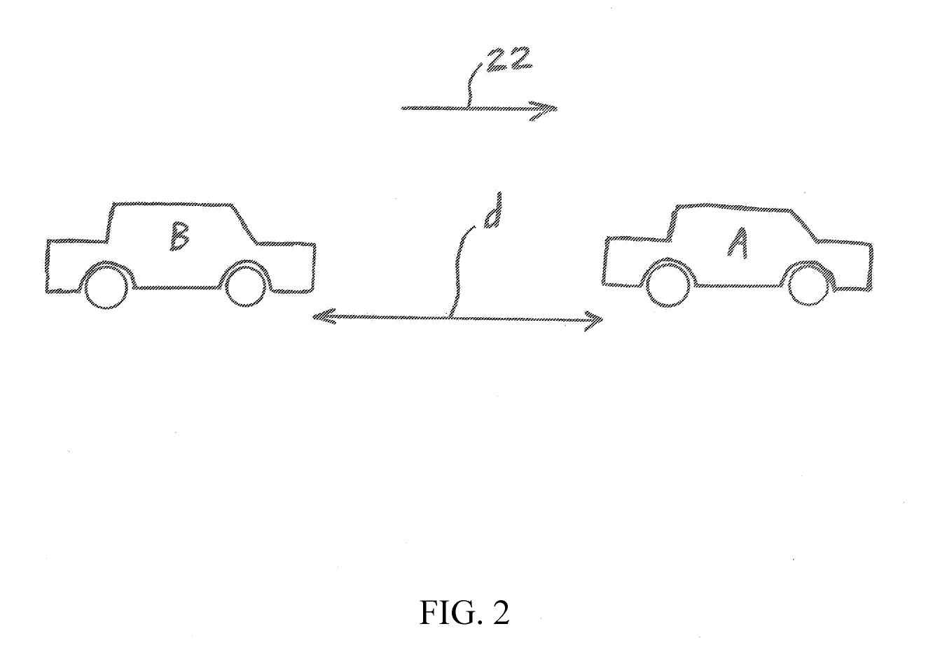

FIG. 2 illustrates a first step of one example use case of arrangement 10. Vehicles A and B are both traveling in direction 22 and are separated by a distance d. Vehicle A is traveling at speed V1 and vehicle B is traveling, at speed V2. If V2 is greater than V1 and distance d is less than some threshold distance, such as 10 meters, then the rear view and other cameras of vehicle A may begin recording and storing their video data in memory 16 in anticipation of a collision.

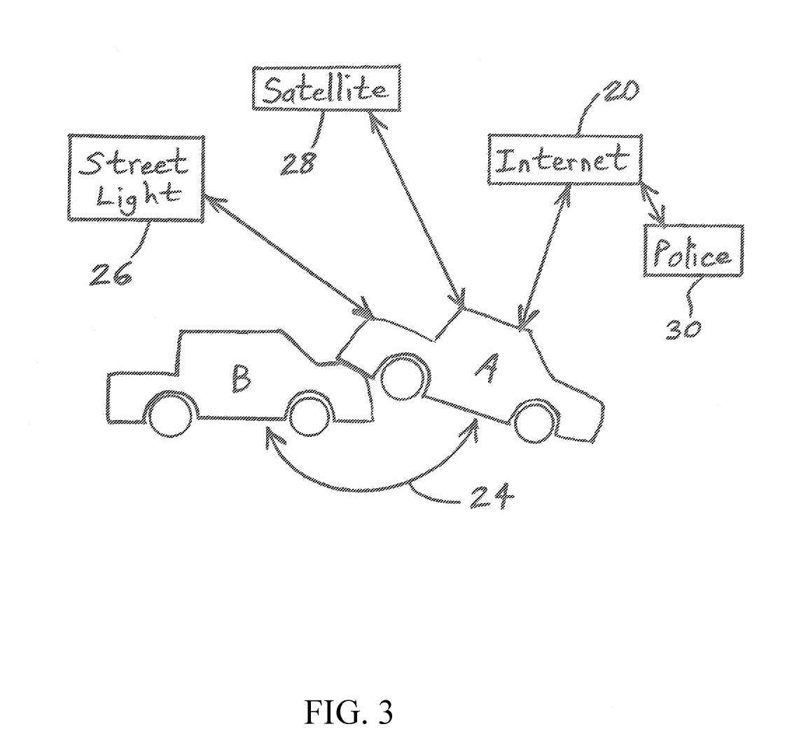

FIG. 3 illustrates a second step of the example use case of FIG. 2. Particularly, FIG. 3 illustrates the scenario after vehicle B has collided with vehicle A. Vehicles A and B may communicate directly with each other, as indicated at 24, via V2V communication, Vehicle A may communicate with infrastructure, such as streetlight 26, via V2X communication. A GPS module within vehicle A may determine the vehicle's global coordinates via communication with satellite 28. Vehicle A may report all the relevant collected data to law enforcement/police authorities 30 via Internet 20. Vehicle A may send the video or picture recording data, the videos, V2V and V2X information, GPS coordinates, and internal vehicle internal sensor readings and data to law enforcement authorities 30.

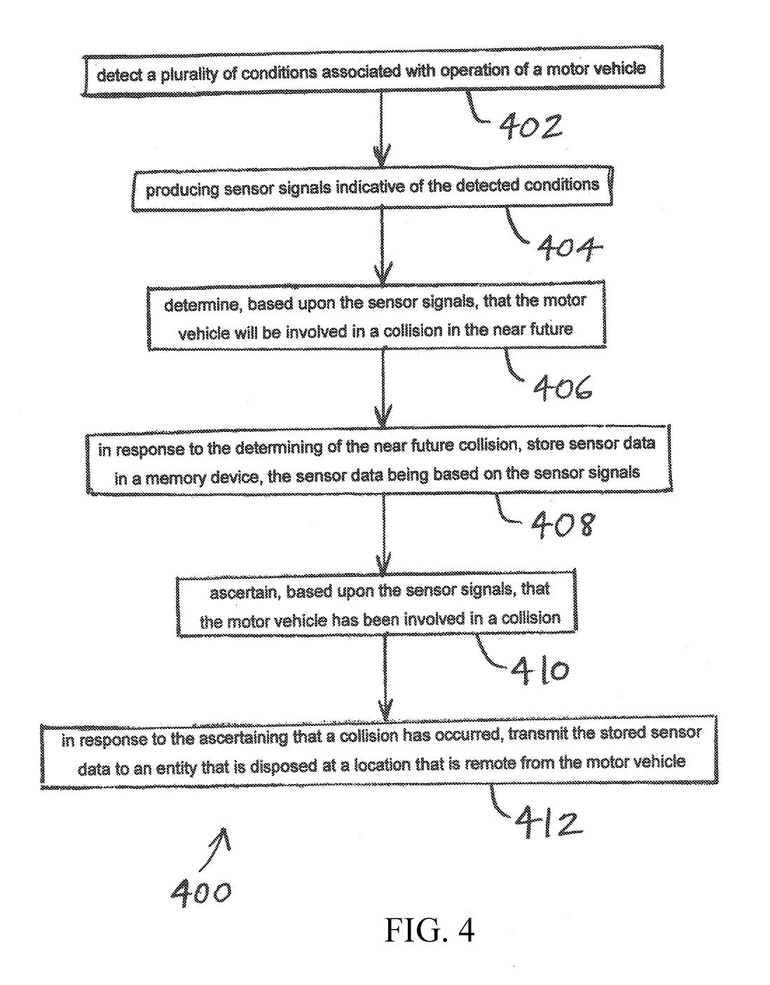

FIG. 4 illustrates one example embodiment of a method 400 of the present invention for reporting a collision of a motor vehicle. In a first step 402, a plurality of conditions associated with operation of the motor vehicle are detected. For example, sensors 18 may include a GPS module, cameras, a speedometer, accelerometers, radar detection sensors, microphones, collision sensors, V2V data collectors, and V2X data collectors which may detect conditions associated with operation of motor vehicle 12.

In a next step 404, sensor signals indicative of the detected conditions are produced. For example, sensors 18 may produce signals indicative of the detected conditions associated with operation of motor vehicle 12.

Next, in step 406, it is determined, based upon the sensor signals, that the motor vehicle will be involved in a collision in the near future. For example, with reference to FIG. 2, if sensors 18 detect that the speed of vehicle B is greater than the speed of vehicle A by more than a threshold amount, and that a distance d between vehicles A and B is less than some threshold distance (which may be dependent upon the difference in speeds between vehicles A and B) such as 5 meters, then it may be determined that there will be a collision between vehicles A and B within the next few seconds.

In step 408, in response to the determining of the near future collision, sensor data is stored in a memory device. The sensor data is based on the sensor signals. For example, information and data collected from sensors 18, and based on signals received from sensors 18, may be recorded in memory device 16.

In a next step 410, it is ascertained, based upon the sensor signals, that the motor vehicle has been involved in a collision. For example, sensors 18 including a speedometer, accelerometers, and/or collision sensors may produce sensor signals that processor 14 may analyze to thereby ascertain that motor vehicle 12 has been in a crash.

In a final step 412, in response to the ascertaining that a collision has occurred, the stored sensor data is transmitted to an entity that is disposed at a location that is remote from the motor vehicle. For example, Vehicle A may report all the relevant collected data to law enforcement/police authorities 30 via Internet 20. Vehicle A may send the video or picture recording data, the videos, V2V and V2X information, GPS coordinates, and internal vehicle internal sensor readings and data to law enforcement authorities 30. The invention has been described as using wireless communication through a network, However, if for some reason network connectivity is not available, the information can be stored in a memory box in the vehicle. Authorities can retrieve the memory box as evidence to prove the root cause of the crash.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or wound, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A crash notification arrangement fur a motor vehicle, the arrangement comprising:
a plurality of sensors configured to:
detect a plurality of conditions associated with operation of the motor vehicle; and
produce sensor signals indicative of the detected conditions; and
an electronic processor communicatively coupled to the sensors and configured to:
receive the sensor signals;
determine, based upon the sensor signals, that the motor vehicle will be involved in a collision in the near future;
in response to the determining of the near future collision, store sensor data in a memory device, the sensor data being based on the sensor signals;
ascertain, based upon the sensor signals, that the motor vehicle has been involved in a collision; and
in response to the ascertaining that a collision has occurred, transmit the stored sensor data to an entity that is disposed at a location that is remote from the motor vehicle.

2. The arrangement of claim 1 wherein the sensors include a speedometer, a gyroscope and/or an accelerometer.

3. The arrangement of claim 1 wherein the sensors include a GPS module.

4. The arrangement of claim 1 wherein the sensors include a radar-based collision sensor.

5. The arrangement of claim 1 wherein the memory device is disposed within the motor vehicle.

6. The arrangement of claim 1 Wherein the sensors include at least one camera and at least one microphone.

7. The arrangement of claim 1 wherein the electronic processor is configured to:
determine based upon the sensor signals that the motor vehicle will be involved in a collision within a period of time of less than five seconds into the future; and
ascertain based upon the sensor signals that the motor vehicle has been involved in a collision within a period of time of less than five seconds into the past.

8. A method for reporting a collision of a motor vehicle, the method comprising:
detecting a plurality of conditions associated with operation of the motor vehicle;
producing sensor signals indicative of the detected conditions;
determining, based upon the sensor signals, that the motor vehicle will be involved in a collision in the near future;
in response to the determining of the near future collision, storing sensor data in a memory device, the sensor data being based on the sensor signals;
ascertaining, based upon the sensor signals, that the motor vehicle has been involved in a collision; and
in response to the ascertaining that a collision has occurred, transmitting the stored sensor data to an entity that is disposed at a location that is remote from the motor vehicle.

9. The method of claim 8 wherein the sensor signals include a speedometer signal, a gyroscope signal and/or an accelerometer signal.

10. The method of claim 8 wherein the sensor signals include a GPS signal.

11. The method of claim 8 wherein the sensor signals include a radar-based collision sensor signal.

12. The method of claim 8 wherein the memory device is disposed within the motor vehicle.

13. The method of claim 8 wherein the sensor signals include at least one video signal and at least one audio signal.

14. The method of claim 8 wherein the determining step includes determining, based upon the sensor signals, that the motor vehicle will be involved in a collision within a period of time of less than five seconds into the future, and the ascertaining step includes ascertaining, based upon the sensor signals, that the motor vehicle has been involved in a collision within a period of time of less than five seconds into the past.

15. A motor vehicle, comprising;
a plurality of sensors configured to:
detect a plurality of conditions associated with operation of the motor vehicle; and
produce sensor signals indicative of the detected conditions;
a memory device; and
an electronic processor communicatively coupled to the sensors and to the memory device, the electronic processor being configured to:
receive the sensor signals;
store sensor data in the memory device, the sensor data being based on the sensor signals;
ascertain, based upon the sensor signals, that the motor vehicle has been involved in a collision; and
in response to the ascertaining that a collision has occurred, transmit the stored sensor data to an entity that is disposed at a location that is remote from the motor vehicle.

16. The motor vehicle of claim 15 wherein the sensors include a speedometer, a gyroscope and/or an accelerometer.

17. The motor vehicle of claim 15 wherein the sensors include a vehicle to vehicle communication module.

18. The motor vehicle of claim 15 wherein the sensors include a vehicle to infrastructure communication module.

19. The motor vehicle of claim 15 wherein the sensors include at least one camera capturing images of a human driver of the motor vehicle.

20. The motor vehicle of claim 15 wherein the motor vehicle comprises a first motor vehicle, the sensors including at least one camera capturing images of a second motor vehicle, the second motor vehicle being on a same road as the first motor vehicle, or on a second road that intersects a first road that the first motor vehicle is on.
